(19) United States
(12) Patent Application Publication
(10) Pub. No.: US 2008/0052925 A1
(43) Pub. Date: Mar. 6, 2008

(54) Drawings device and drawing method

(75) Inventor: Takuya Hirashima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/896,304

(22) Filed: Aug. 30, 2007

(30) Foreign Application Priority Data
Sep. 1, 2006 (JP) 2006-237757

(51) Int. Cl. B43L 13/00

(52) U.S. Cl. 33/18.1

(57) ABSTRACT

A drawing device, comprising: a setting portion that sets: standard mark position data relating to positions of a plurality of standard marks provided on a drawing medium at which a plurality of images are drawn at respective predetermined drawing regions; drawing position data relating to positions of a plurality of drawing regions; and standard mark correspondence data showing a corresponding relation between the positions of the plurality of standard marks and the plurality of drawing regions; a detecting portion that detects the positions of the plurality of standard marks and obtains the detected position data; a correcting portion that corrects drawing positions of the plurality of drawing regions based on the standard mark position data, the drawing position data, the standard mark correspondence data, and the detected position data; and a drawing portion that draws the plurality of images at the corrected drawing positions on the drawing medium, is provided.

### CROSS-REFERENCE TO RELATED APPLICATION

This application claims priority under 35 USC 119 from Japanese Patent Application No. 2006-237757, the disclosure of which is incorporated by reference herein.

### BACKGROUND

1. Technical Field

The present invention relates to a drawing device and a drawing method, especially to a drawing device and method whereby an image is arranged at a predetermined position of an object to be drawn and is then drawn.

2. Related Art

Conventionally, as devices for drawing a predetermined wiring pattern on the substrate of a printed circuit board, there have been various proposals for exposure devices that use photolithograph technologies.

An example of such a proposed exposure device is a device that scans a light beam in main scanning and sub scanning directions on a substrate coated with a photo resist, and which forms a wiring pattern by modulating the light beam based on image data that represents the wiring pattern.

Here, there is a trend that the wiring patterns of printed circuit boards formed by exposure devices such as those described above are becoming more and more high-definition. In, for example, a case where multiple layer printed circuit boards are formed, it is necessary to perform position matching of the wiring patterns of each layer with a high degree of accuracy.

In order to perform this position matching, the wiring patterns of each layer are exposed at preset positions on the substrate. When forming a multilayered printed circuit board, the substrate is heated in a press that sticks each layer together. Since there are cases where the substrate deforms due to that heat, drawing position deviation of the wiring pattern of each layer occur when these wiring patterns are exposed at the preset positions, and there is a possibility that position matching of the wiring patterns of each layer will not be able to be performed with a high degree of accuracy.

Here, an exposure device has been proposed where, for example, holes are provided in the four corners of the substrate of each layer based on preset standard mark position data, and when exposing, the positions of these holes are detected and the amount of deformation of the substrate is evaluated based on the detected position data of the detected holes and the standard mark position data. By correcting the arrangement of the wiring pattern in accordance with this amount of deformation, the device can perform highly precise position matching without being affected by the aforementioned deformation of the substrate.

Recently, the demand for relatively small-sized printed circuit boards is increasing with the increasing popularity of small electronic devices such as mobile phones. When manufacturing small-sized printed circuit boards such as those described above using the above-described exposure device, exposure is performed so that many small-sized wiring patterns are arranged within a single large-sized substrate.

Nonetheless, when exposing many wiring patterns on one substrate, if the overall image including many wiring patterns is corrected based on holes provided in the four corners of the substrate and exposed as described above, there are cases where deformations of the substrate do not occur evenly throughout the overall substrate but differ partially. For this reason, there is a possibility that highly accurate position matching of each of the individual wiring patterns will not be possible.

Here, methods have been proposed where, for example, standard marks are each provided in accordance with the individual small-sized wiring patterns as opposed to in the four corners of the substrate. With this method, each individual drawing position of the wiring pattern is corrected based on the deviation between the actual positions of the standard marks provided at each wiring pattern and the positions where they would usually be found. (For example, see Japanese Patent Application Laid-Open (JP-A) Nos. 2005-300628 and 2000-122303.)

Nonetheless, with the above-described conventional technologies, the correspondence between the standard marks and the wiring patterns (i.e., the drawing regions) is fixed. This has been problematic in that there are limitations on the arrangement, number, and shapes of the standard marks and on the shapes of the drawing regions.

### SUMMARY

The present invention is invented in order to solve the above-described problems, and an object thereof is to provide a drawing device and drawing method with which limitations on aspects such as the arrangement of standard marks can be eliminated.

In order to solve this problem, a drawing device of a first aspect of the present invention comprises: a setting portion that sets: standard mark position data relating to positions of plural standard marks provided on a drawing medium at which plural images are drawn at respective predetermined drawing regions; drawing position data relating to positions of plural drawing regions; and standard mark correspondence data showing a corresponding relation between the positions of the plural standard marks and the plural drawing regions; a detecting portion that detects the positions of the plural standard marks and obtains detected position data showing the positions of the detected standard marks; a correcting portion that corrects drawing positions of the plural drawing regions based on the standard mark position data, the drawing position data, the standard mark correspondence data, and the detected position data; and a drawing portion that draws the plural images at each of the corrected drawing positions on the drawing medium.

Due to this invention, the setting portion can individually set the standard mark position data and the drawing position data, and can set the corresponding relation between the positions of the standard marks and the drawing regions as the standard mark correspondence data.

Then, the correcting portion corrects the drawing positions of the plural drawing regions, based on the standard mark position data, the drawing position data, and the standard mark correspondence data set by the setting portion and the detected position data showing the positions of the standard marks detected by the detecting portion.

The drawing portion draws plural images at each of the drawing positions corrected by the correcting portion on the drawing medium.

In this manner, the standard mark position data and the drawing position data can be set individually, and the corresponding relation between the positions of the standard marks and the drawing regions can be set as the standard mark correspondence data. For this reason, limitations on aspects such as the arrangement, number, and shapes of the standard marks and the shapes of the drawing regions can be eliminated.

Note that, as seen in a second aspect, the correcting portion is provided with a computing portion that computes a correction parameter for correcting a drawing position of a drawing region based on a position of a standard mark that corresponds with a drawing region set by the standard mark correspondence data and the detected position of the standard mark; and a calculating portion that calculates the drawing position of the drawing region based on the correction parameter.

Also, as in a third aspect, the setting portion is configured to further set standard mark shape data relating to shapes of the plural standard marks.

Further, as in a fourth aspect, the drawing portion is an exposing portion that exposes the plural images at each of the corrected drawing positions on the drawing medium.

A drawing method of a fifth aspect of the present invention comprises setting standard mark position data relating to positions of plural standard marks provided on a drawing medium at which plural images are drawn at respective predetermined drawing regions; drawing position data relating to positions of plural drawing regions; and standard mark correspondence data showing a corresponding relation between the positions of the plural standard marks and the plural drawing regions; detecting the positions of plural standard marks and obtaining detected position data showing the positions of the detected standard marks; correcting drawing positions of the plural drawing regions based on the standard mark position data, the drawing position data, the standard mark correspondence data, and the detected position data; and drawing the plural images at each of the corrected drawing positions on the drawing.

Due to the present invention, the standard mark position data and the drawing position data can be individually set, and the corresponding relation between the positions of the standard marks and the drawing regions can be set as the standard mark correspondence data. Accordingly, limitations on aspects such as the arrangement, number, and shapes of the standard marks and the shapes of the drawing regions can be eliminated.

A drawing method according to a sixth aspect of the present invention comprises preparing standard mark position data relating to positions of plural standard marks provided on a drawing medium; drawing position data relating to positions of plural of drawing regions; and standard mark correspondence data showing a corresponding relation between the positions of plural standard marks and plural drawing regions; detecting the positions of plural of standard marks and obtaining detected position data showing the positions of the detected standard marks; correcting the regions corresponding to plural drawing regions in image data based on the standard mark position data, the drawing position data, the standard mark correspondence data, and the detected position data; and drawing on the drawing medium based on the corrected image data.

Due to the present invention, the standard mark position data and the drawing position data can be individually set, and the corresponding relation between the positions of the standard marks and the drawing regions can be set as the standard mark correspondence data. Accordingly, limitations on aspects such as the arrangement, number, and shapes of the standard marks and the shapes of the drawing regions can be eliminated.

The present invention has an effect in that it can eliminate limitations on the arrangement of the standard marks and the like.

### BRIEF DESCRIPTION OF THE DRAWINGS

An exemplary embodiment of the present invention will be described in detail based on the following figures, wherein:

FIG. 1 is a perspective drawing showing the schematic configuration of an exposure device using an exemplary embodiment of the drawing method and device of the present invention;

FIG. 2 is a perspective drawing showing the configuration of a scanner of the exposure device;

FIG. 3A is a plane drawing showing the exposed regions formed on the exposure surface of a substrate;

FIG. 3B is a plane drawing showing the arrangement of the areas exposed by each exposure head;

FIG. 4 is a drawing showing a DMD in the exposure head of the exposure device;

FIG. 5 is a block diagram showing the configuration of an electronic control system of the exposure device;

FIG. 6 is a block diagram showing each type of data stored in a standard position-setting portion;

FIG. 7 is a drawing showing one example of the arrangements of standard marks and drawing regions;

FIG. 8 is a drawing for explaining the correction of drawing positions; and

FIG. 9 is a drawing showing another example of the arrangements of standard marks and drawing regions.

### DETAILED DESCRIPTION

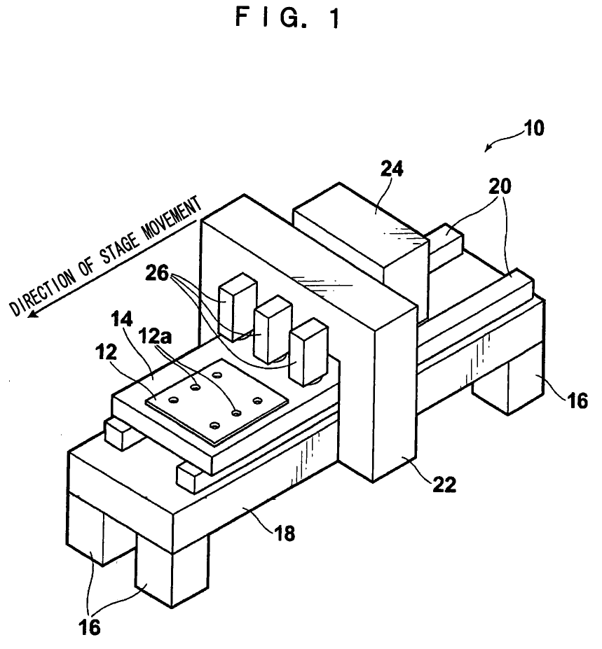

Hereafter, an exposure device using an exemplary embodiment of the drawing method and device according to the present invention will be explained in detail while referring to the drawings. FIG. 1 is a perspective drawing showing the schematic configuration of the present exposure device. The present exposure device is a device that exposes images of multiple wiring patterns and the like on a single substrate, and it exposes the wiring pattern of each layer of a multilayer substrate such as a multilayer printed circuit board. Note that the present embodiment can also be used for a single layer substrate. Also, the substrate can be various structures such as a filter for a displaying device or a semiconductor and the like. Firstly, the schematic configuration of the present exposure device will be explained.

The present exposure device 10 is provided with a flat plate-shaped moving stage 14 on whose surface a substrate 12 is adsorbed and retained, as shown in FIG. 1. Also, two guides 20 that extend along the direction in which the stage moves are arranged on the upper surface of a thick, board-shaped mounting table 18 supported by four legs 16. The moving stage 14 is arranged so that the longitudinal direction thereof follows along the direction of stage movement, and is supported by the guides 20 so as to be movable back and forth.

An inverted U-shaped gate 22 is provided at the central portion of the mounting table 18 so as to straddle the path of movement of the moving stage 14. Both end portions of the inverted U-shaped gate 22 are fixed at both sides of the mounting table 18. This gate 22 is sandwiched between a scanner 24 that is provided at one side and plural cameras 26 (in the present embodiment, three) on the other side. The cameras 26 are for detecting the leading edge and rear edge of the substrate 12 at the other side as well as the positions of plural circular standard marks 12a (six in the present embodiment) provided in advance in the substrate 12.

Here, the standard marks 12a on the substrate 12 are, for example, holes that are formed in the substrate 12 based on preset standard mark position data on and standard mark shape data. Note that besides holes, lands, vias, or etching marks can also be used. Also, as the standard marks 12a, a predetermined pattern, e.g., a part of a circuit pattern that is exposed on the substrate 12 can be used. The shape of the standard mark can be made into an optional shape such as a circular, quadrangular, or triangular shape. The standard mark position data and the standard mark shape data will be described in detail later.

The scanner 24 and the cameras 26 are respectively attached to the gate 22 and are fixed and arranged above the movement path of the moving stage 14. Note that the scanner 24 and the cameras 26 are connected to a controller, which controls them and will be described later.

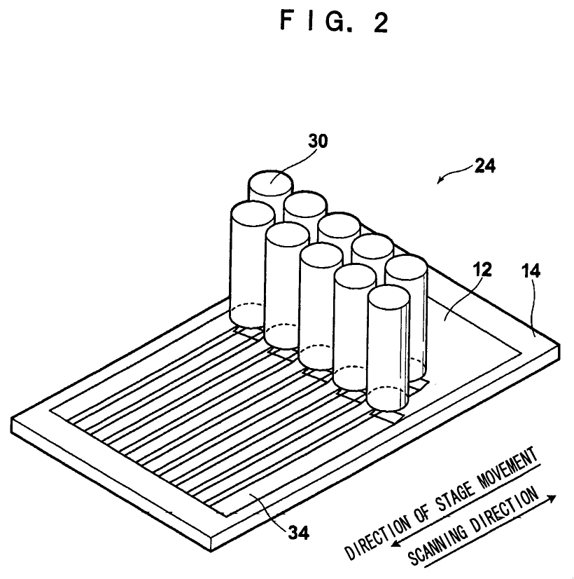

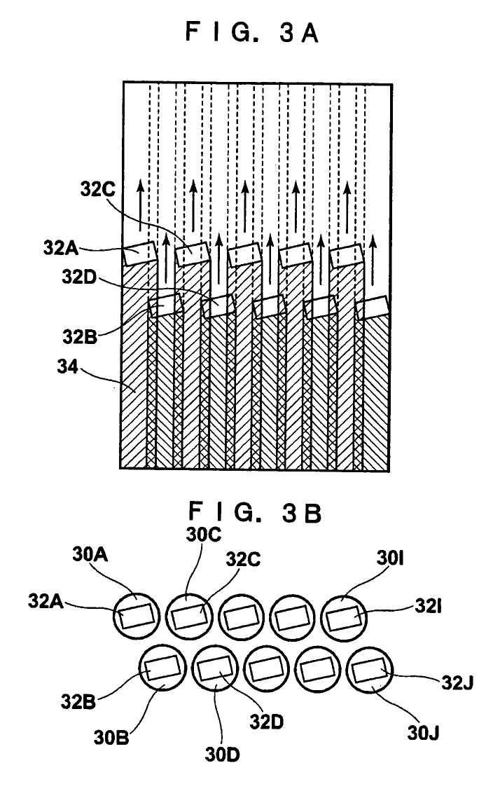

As shown in FIGS. 2 and 3B, the scanner 24 is provided with ten exposure heads 30 (30A-30J) arranged in a substantially matrix-shaped form of two lines of five in a row.

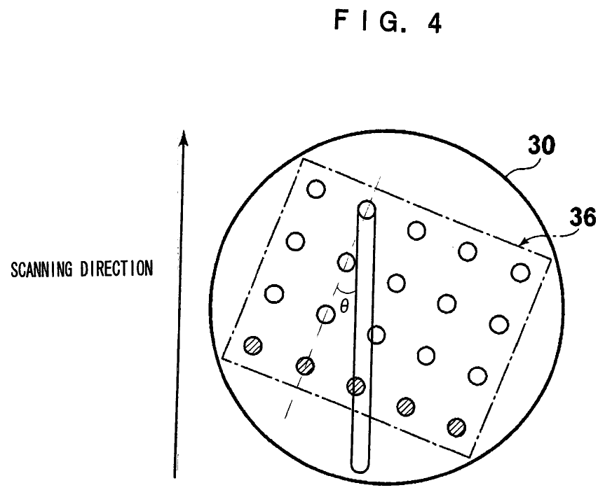

As shown in FIG. 4, a digital micro-mirror device (DMD) 36, which is a spatial light modulator (SLM) that spatially modulates incident light beams, is provided in the interior of each exposure head 30. The DMD 36 is attached such that the direction of the pixel rows thereof becomes a predetermined angle of inclination θ relative to the scanning. Accordingly, an exposure area 32 of each exposure head 30 becomes a rectangular area that is inclined relative to the scanning direction. With the movement of the moving stage 14, a belt-shaped exposed region 34 is formed on the substrate 12 for each exposure head 30. Note that an SLM that is not a DMD can also be used.

On/off control of the DMD 36 provided in each exposure head 30 is performed at micro-mirror unit, and dot patterns (black and white) corresponding to the micro-mirrors of the DMD 36 are exposed on the substrate 12. As shown in FIG. 4, the above-described belt-shaped exposed regions 34 are formed from dots that are arranged two-dimensionally.

The two-dimensionally arranged dot pattern is slanted relative to the scanning direction, whereby the dots lined in the scanning direction become such that they pass through in between the dots lined in the direction that intersects the scanning direction, so a higher resolution can be achieved.

Note that due to variations of adjustment in the angle of inclination, there are also instances where there are dots that are not being used, e.g., in FIG. 4, the dots that are in slanted lines are not in use so the micro-mirrors in the DMD 36 corresponding to these dots are usually in the off state.

Also, as shown in FIGS. 3A and 3B, each line of the exposure heads 30 arranged in line formation are staggered and arranged at predetermined intervals in the direction in which they are arranged (i.e., a certain natural number times as long as the long side of the exposure area: in the present embodiment, times one). Due to this, each belt-shaped exposed region 34 partially overlaps with the adjoining exposed region 34. For this reason, a part that cannot be exposed that is in between, e.g., the exposure area 32A positioned at the furthest left side of the first line and the exposure area 32C positioned next to the exposure area 32A to its right is exposed by the exposure area 32B positioned at the furthest left side of the second line. Similarly, the part that cannot be exposed between the exposure area 32B and the exposure area 32D positioned next to the exposure area 32B to its right is exposed by the exposure area 32C.

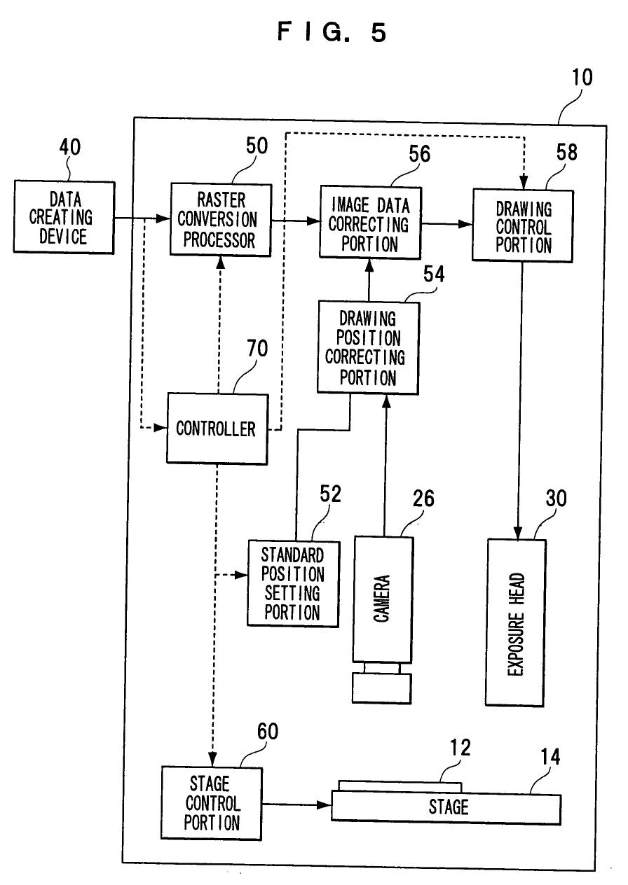

Next, the electrical configuration of the present exposure device 10 will be explained. As shown in FIG. 5, the present exposure device 10 is provided with: a raster conversion processor 50 that receives vector data that is outputted from a data creating device 40 (which has a computer aided manufacturing (CAM) station) and which represents the wiring pattern of the object to be exposed, and converts the vector data into raster data (i.e., bitmap data); a standard position-setting portion 52 in which the following are set (i.e., stored): standard mark position data relating to the positions of standard marks 12a provided on the substrate 12; standard mark shape data relating to the shapes of the standard marks 12a; drawing position data relating to the drawing positions of plural drawing regions; and standard mark correspondence data relating to the corresponding relations between the standard marks and the drawing regions; a drawing position-correcting portion 54 that corrects the above-described drawing position data based on the detected position data that represents the positions of the standard marks 12a detected by the cameras 26, and the standard mark position data, and the standard mark correspondence data; an image data-correcting portion 56 that corrects the raster data of the wiring pattern (i.e., drawing region) based on the drawing position data corrected by the drawing position-correcting portion 54 and produces corrected image data; a drawing control portion 58 that controls the exposure heads 30 so that exposure is performed by the exposure heads 30 based on the corrected image data converted by the image data-correcting portion 56; a stage control portion 60 that controls movement of the moving stage 14 in the direction in which the stage moves; and a controller 70 that controls the overall present exposure device. Note that the above-described standard mark position data, standard mark shape data, drawing position data, and standard mark correspondence data can be set by the user's operations in, e.g., at the standard position-setting portion 52. This data will be explained in detail later.

Next, the action of the present exposure device 10 will be explained while referring to FIG. 5.

First, vector data that represents the overall image pattern, including plural wiring patterns that are to be exposed on the substrate 12, is created in the data creating device 40. Then, this vector data is inputted into the raster conversion processor 50 where it is converted into raster data, and then inputted to the image data-correcting portion 56, which temporarily stores the inputted raster data.

Also, when the vector data is inputted into the raster conversion processor 50 as described above, the controller 70 that controls the action of the overall exposure device 10 outputs a command signal to the stage control portion 60, and the stage control portion 60 outputs a control signal to a stage driving device (not shown) in accordance with that command signal. In response to that control signal, the stage-driving device makes the moving stage 14 move once along the guides 20 from the position shown in FIG. 1 to a predetermined starting position at the upstream side, after which it moves the moving stage 14 toward the direction of stage movement at the desired speed.

Then, when the substrate 12 on the moving stage 14 that moves as described above passes underneath the plural cameras 26, the substrate 12 is photographed by these cameras 26 and image data that represents the photographed images is inputted into the drawing position-correcting portion 54.

The drawing position-correcting portion 54 detects the positions of the standard marks 12a of the substrate 12 mounted on the moving stage 14 based on the image data and the standard mark shape data, and then obtains the detected position data.

With regard to the method for detecting the positions of the standard marks 12a, the device can be designed to detect them by, e.g., extracting an image of the shape of each standard mark set in the standard mark shape data, or other known detection methods can also be used.

Also, the detected position data for the above-described standard marks 12a is specifically obtained as coordinate values, and the origin of the coordinate values can be, e.g., one of the four corners of the photographed image of the substrate 12. The origin can also be a predetermined position set in the photographed image in advance, or the position of one of the standard marks 12a from among the plural standard marks 12a. Nonetheless, it is necessary to make the origin, set as described above, and the origin of the coordinate values of the standard mark position data comply with each other.

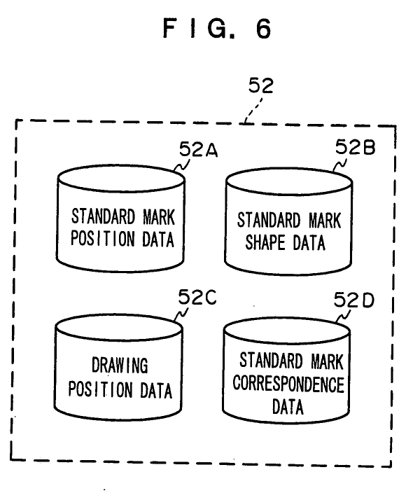

As shown in FIG. 6, a standard mark position data 52A of the standard marks 12a in a standard substrate 12 that has not undergone the above-described press processing is set in the standard position-setting portion 52 in advance. This standard mark position data 52A is a design value and is a value set in advance when providing the standard marks 12a on the substrate 12.

Further, this standard mark position data 52A can be set by the user. Also, it can be set by obtaining the position of the standard mark by photographing the standard substrate 12, e.g., as described above, with the cameras 26 described above. The above-described standard mark position data 52A is also set as a coordinate value. That is, the standard mark position data 52A can be data that represents the corresponding relation between, e.g., intrinsic mark numbers for each standard mark and the coordinate value.

Further, a standard mark shape data 52B that represents the shape of the standard marks 12a is set in the standard position-setting portion 52 in advance, as is shown in FIG. 6. This standard mark shape data 52B can be made to be, e.g., image data of the shape of the standard marks 12a. That is, the standard mark shape data 52B can be made into data that represents e.g., the corresponding relation between the mark number and image data on the shape of the standard marks. Note that this standard mark shape data 52B can be set by the user. Further, it can be set by obtaining the shape of the standard mark by, e.g., as described above, photographing the standard substrate 12 as described above with the cameras 26.

Further, as shown in FIG. 6, a drawing position data 52C for plural drawing regions that are to be drawn on the substrate 12 is set in the standard position-setting portion 52. Here, the term “drawing region” refers to the region in which the wiring pattern is formed and is, e.g., a divided region acting as a small substrate. This drawing position data 52C is data for setting, e.g., the boundaries (i.e., outline) of the drawing region. When, for example, the drawing region is rectangular, the corner portions of that rectangular region can be made as the setting points of the drawing region and made as the coordinate values. That is, the drawing position data 52C can be made into data that represents the corresponding relation between, e.g., an intrinsic drawing region number at each drawing region and the coordinate value of each setting point for each drawing region. Note that this drawing position data 52C can be set by the user.

Furthermore, as shown in FIG. 6, a standard mark correspondence data 52D that represents the corresponding relation between the standard marks and the drawing regions is set in the standard position-setting portion 52. This standard mark correspondence data 52D is data where a determination is made regarding which standard mark to use and which drawing position of the drawing region to correct when correcting the drawing position of the drawing region in the drawing position correcting portion 54. That is, the standard mark correspondence data 52D can be made to be data that represents, e.g., the corresponding relation between a drawing region number of a drawing region and a mark number of a standard mark. Note that this standard mark correspondence data 52D can also be set by the user.

In this manner, with the present exemplary embodiment, the standard mark position data 52A, standard mark shape data 52B, and drawing position data 52C can each be set independently, and by setting the standard mark correspondence data 52D, the correspondence between the drawing region and the standard mark can be optionally set. Due to this, limitations that occur on aspects such as the arrangement, shape, and number of the standard marks and the shape of the drawing regions can be eliminated.

The standard mark position data 52A, standard mark shape data 52B, drawing position data 52C, and standard mark correspondence data 52D set as described above are outputted from the standard position-setting portion 52 to the drawing position correcting portion 54.

The drawing position correcting portion 54 calculates the amount of deviation between the detected position and the standard mark position based on the detected position data of the standard marks 12a of the substrate 12 actually photographed with the cameras 26 as described above and the standard mark position data 52A outputted from the standard position-setting portion 52, and based on that amount of deviation, corrects the drawing position data 52C. This is performed for each drawing region. Note that examples of the amount of deviation include the amount of shift, the amount of rotation, or scale ratios in a drawing region.

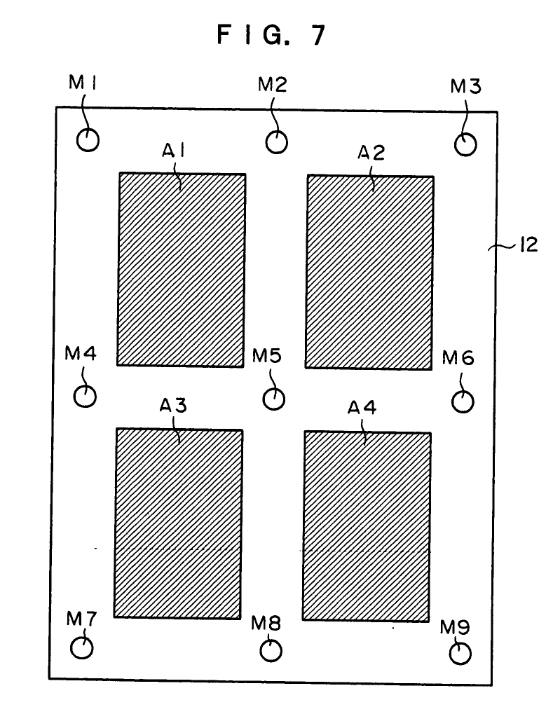

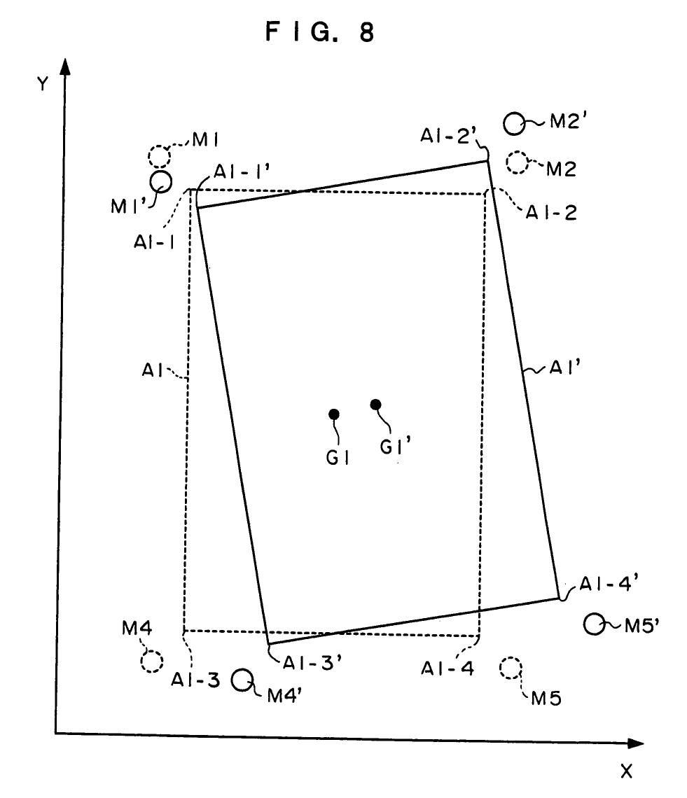

Here, the method for correcting the drawing position data 52C will be specifically explained while referring to FIGS. 7 and 8. Here, as shown in FIG. 7, explanations will be given for a case where four drawing regions A1-A4 are arranged on the substrate 12 and nine circular standard marks M1-M9 are provided thereon.

In a case like this, the standard mark correspondence data 52D can attach correspondence between, e.g., drawing region A1 and standard marks M1, M2, M4, and M5; drawing region A2 and standard marks M2, M3, M5, and M6; drawing region A3 and standard marks M4, M5, M7, and M8; and drawing region A4 and standard marks M5, M6, M8, and M9. Note that this is just one example, and as described above, the standard marks in the periphery of a drawing region can be made to correspond to the drawing region. An optional standard mark can have correspondence attached to the drawing region so that, e.g., correspondence is attached between the drawing region A1 and the standard marks M5, M6, M8, and M9. Further, the shapes of the standard marks are also not limited to round shapes and can be other shapes, and standard marks with differing shapes can also be mixed. Furthermore, the number of standard marks corresponding to one drawing region can be any number of at least two or more, and the number of standard marks corresponding to each drawing region can also differ.

Hereafter, correction of the drawing position in a case where correspondence exists between a drawing region A1 and standard marks M1, M2, M4, and M5 will be explained.

As shown in FIG. 8, in a case when the actual detected positions of the standard marks M1, M2, M4, and M5 are M1′, M2′, M4′, and M5′, based, e.g., on these coordinate values, the following correction parameters are computed: the amount of rotation of the drawing region A1′ to be actually drawn (i.e., the angle of inclination of the drawing region A1′ to be actually drawn relative to the set drawing region A1); the amount of shift of the drawing region A1′ to be actually drawn in each of the X direction (i.e., the direction parallel to the short side of the drawing region A1) and Y direction (i.e., the direction parallel to the long side of the drawing region A1) shown in FIG. 8; and the scale ratios in the X direction and Y direction of each side of the drawing region. Note that the scale ratio is the ratio of a length of one side of the drawing region A1′ that should actually be drawn relative to the length of one side of the set drawing region A1. Also, the amount of shift can be sought based on the distance (i.e., amount of offsetting) between the gravity center position G1 of the set drawing region A1 and the gravity center position G1′ of the drawing region A1′ to be actually drawn.

With regard to the method of seeking the correction parameters, a well-known method can be used such as the one recited in the above-described JP-A No. 2005-300628.

The drawing position-correcting portion 54 computes the correction parameters for each drawing region as described above. Then the position of each drawing region is corrected based on the correction parameters. That is, the positions of the drawing region setting points A1-1′, A1-2′, A1-3′, and A1-4′ of the drawing region A1′ that should actually be drawn, where the positions of the drawing region set points A1-1, A1-2, A1-3, and A1-4 of the set drawing region A1 have been corrected. Due to this, the position of the drawing region can be corrected in response to distortion and the like of the substrate 12. This is performed for each drawing region, and the drawing position data 52C is corrected.

The corrected drawing position data 52C is outputted to the image data-correcting portion 56. The image data-correcting portion 56 executes processing such as rotation, shifting, and variable power on the raster data stored once in advance based on the post-corrected inputted drawing position data 52C. Note that in FIG. 8, it appears that the drawing region is only shifted and rotated, however, expansion and contraction of the drawing region can also be corrected by variable power processing based on the drawing position data corrected as described above. Deformations can also be included in the expansion and contraction of the drawing region.

When the corrected raster data is calculated as described above, the moving stage 14 is made to move from the downstream side position shown in FIG. 1 to the upstream side at a desired speed.

Then, when the leading edge of the substrate 12 is detected by the cameras 26, exposure is started. Specifically, as described above, the calculated and corrected raster data is outputted to the drawing control portion 58 and the drawing control portion 58 outputs a control signal to each exposure head 30 of the scanner 24 based on the inputted and corrected raster data. The exposure heads 30 turn the micro-mirrors of the DMD 36 on or off based on that control signal and expose the wiring pattern in accordance with the corrected raster data on the substrate 12.

Then, with the movement of the moving stage 14, control signals are gradually outputted to each of the exposure heads 30 and exposure is performed, and when the rear edge of the substrate 12 is detected by the cameras 26, exposure is stopped.

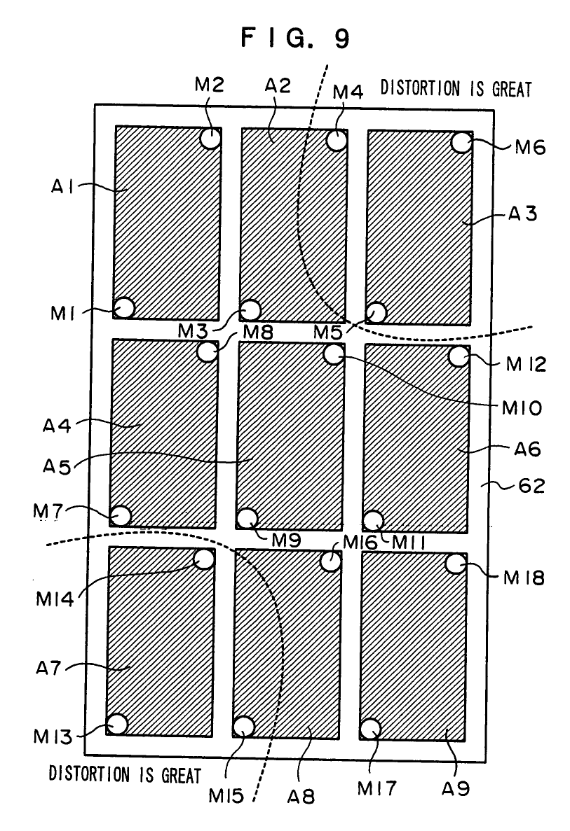

In this manner, with the present exemplary embodiment, the standard mark position data, standard mark shape data, and drawing position data can each be independently set. By setting the standard mark correspondence data, the correspondence between the drawing-region and the standard mark can be optionally set. Due to this, limitations that occur on aspects such as the arrangement, shape, and number of the standard marks and on the shape of the drawing regions can be eliminated. Accordingly, as seen in the example of a substrate 62 shown in FIG. 9, standard marks M1-M18 can be arranged with two for each of the drawing regions A1-A9 at the inner side thereof as opposed to the outer side. Then, in a case where, e.g., distortion of the substrate 62 is great at the outer sides as shown with the dotted lines in the same drawing, correspondence can be attached to, e.g., drawing region A3 with standard marks M4, M5, and M3, which is primarily for drawing region A2. On the other hand, with regard to drawing region A5 where distortion of the substrate is slight, correspondence can be attached as usual with standard marks M9 and M10. In this manner, with the present exemplary embodiment, attachment of correspondence between the standard marks and the drawing regions can be optionally set in response to the distorted positions of the substrate, so it becomes possible to correct drawing positions with even greater accuracy.

Note that with the present exemplary embodiment, a case is explained where the drawing position is corrected in response to deviation of the standard mark, however, this is not thus limited. For example, the shape similar to that of the drawing region can be made as the shape of the standard mark. The drawing position can be corrected by making the drawing region deform in response to detected deformations in the standard mark.

Further, with the present exemplary embodiment, an example is explained where the present invention is applied to an exposure device and exposure method, however, the present invention is not thus limited. For example, the present invention can be used in coating devices and methods that coat a solder resist or the like on predetermined regions of a substrate, or even in inkjet printers and inkjet type printing methods and the like. That is, the present invention can also be applied to devices that perform drawing by the dotting of discharged droplets.

What is claimed is:

1. A drawing device, comprising:
a setting portion that sets: standard mark position data relating to positions of a plurality of standard marks provided on a drawing medium at which a plurality of images are drawn at respective predetermined drawing regions; drawing position data relating to positions of a plurality of drawing regions; and standard mark correspondence data showing a corresponding relation between the positions of the plurality of standard marks and the plurality of drawing regions;
a detecting portion that detects the positions of the plurality of standard marks and obtains detected position data showing the positions of the detected standard marks;
a correcting portion that corrects drawing positions of the plurality of drawing regions based on the standard mark position data, the drawing position data, the standard mark correspondence data, and the detected position data; and
a drawing portion that draws the plurality of images at each of the corrected drawing positions on the drawing medium.

2. The drawing device of claim 1, wherein the correcting portion is provided with a computing portion that computes a correction parameter for correcting a drawing position of a drawing region based on a position of a standard mark that corresponds with a drawing region set by the standard mark correspondence data and the detected position of the standard mark; and a calculating portion that calculates the drawing position of the drawing region based on the correction parameter.

3. The drawing device of claim 1, wherein the setting portion is configured to further set standard mark shape data relating to shapes of the plurality of standard marks.

4. The drawing device of claim 2, wherein the setting portion is configured to further set standard mark shape data relating to the shapes of the plurality of standard marks.

5. The drawing device of claim 1, wherein the drawing portion is an exposing portion that exposes the plurality of images at each of the corrected drawing positions on the drawing medium.

6. The drawing device of claim 3, wherein the standard mark position data, the drawing position data, and the standard mark shape data are each set independently.

7. The drawing device of claim 2, wherein the correction parameter includes an amount of shift, an amount of rotation and a scale ratio of the drawing region.

8. The drawing device of claim 2, wherein the number of standard marks corresponding to one drawing region is any given number of two or more.

9. A drawing method, comprising:
setting standard mark position data relating to positions of a plurality of standard marks provided on a drawing medium at which a plurality of images are drawn at respective predetermined drawing regions; drawing position data relating to positions of a plurality of drawing regions; and standard mark correspondence data showing a corresponding relation between the positions of the plurality of standard marks and the plurality of drawing regions;
detecting the positions of the plurality of standard marks and obtaining detected position data showing the positions of the detected standard marks;
correcting drawing positions of the plurality of drawing regions based on the standard mark position data, the drawing position data, the standard mark correspondence data, and the detected position data; and
drawing the plurality of images at each of the corrected drawing positions on the drawing medium.

10. A drawing method, comprising:
preparing standard mark position data relating to positions of a plurality of standard marks provided on a drawing medium; drawing position data relating to positions of a plurality of drawing regions; and standard mark correspondence data showing a corresponding relation between the positions of the plurality of standard marks and the plurality of drawing regions;
detecting the positions of the plurality of standard marks and obtaining detected position data showing the positions of the detected standard marks;
correcting the regions corresponding to the plurality of drawing regions in image data based on the standard mark position data, the drawing position data, the standard mark correspondence data, and the detected position data; and
drawing on the drawing medium based on the corrected image data.
